(19) United States
(12) Patent Application Publication
(10) Pub. No.: US 2017/0264662 A1
(43) Pub. Date: Sep. 14, 2017

(54) METHOD AND APPARATUS FOR THE TRANSMISSION OF THE VIDEO STREAM WITH THE COMMENT DATA

(71) Applicant: Shanghai Hode Information Technology Co.,Ltd., Shanghai (CN)

(72) Inventors: Yi XU, Shanghai (CN); Fan LAN, Shanghai (CN)

(21) Appl. No.: 15/456,319

(22) Filed: Mar. 10, 2017

(30) Foreign Application Priority Data
Mar. 11, 2016 (CN) 201610138006.4

(51) Int. Cl. H04L 29/06; H04L 12/58

(52) U.S. Cl. CPC H04L 65/601; H04L 51/046; H04L 65/4084; H04L 67/42

(57) ABSTRACT

This invention relates generally to the video stream of the comment data and more particularly to the method and apparatus for the transmission of the video stream of the comment data. A method comprising: receiving content data associated with a presentation of a content item, wherein the content data comprises attribute information corresponding to the content data; receiving comment data, wherein the comment data comprises a plurality of comment data segments and attribute information corresponding to the plurality of comment data segments; integrating the plurality of comment data segments into the content data based on their respective attribute information and generating an integrated data stream; and transmitting, to a client computing device, the integrated data stream, saving the bandwidth required by decoding and greatly unleashing the decoding speed of the comment data video; improving the viewability of the comment data; enhanced the adaptability of advanced comments.

### CROSS-REFERENCE TO RELATED APPLICATION

The present application claims priority to Chinese Patent Application No. 201610138006.4, filed on Mar. 11, 2016, and the entire contents of which are hereby incorporated by reference.

### FIELD OF THE INVENTION

This invention relates generally to the video stream of the comment data and more particularly to the method and apparatus for the transmission of the video stream of the comment data.

### BACKGROUND OF THE INVENTION

Comment data refers to the presentation of both a video and the Comments on it on the same screen. The Comments scroll on the screen look like bullets, hence the name comment data. The comment data will be displayed real-time as a video is being played, so that a viewer, when watching the video, can see comment data messages sent by himself/herself and other viewers.

When an online video is being played, the server can obtain comment data messages from the terminal, and then, from time to time, add users' comment data comments on the online video to the online video to be displayed, so that a user, when watching the online video, can easily read the Comments sent by users.

Video stream refers to the transmission of video data. For example, it can be deemed a steady, continuous stream and be processed through the network. As it is a stream, the client browser or plug-in can display multimedia data before the whole file is completely transmitted. The video stream technology is based on the development of the 2-key technology, video decoding technologies and upgradable video distribution technologies.

With the development of the Internet, the online transmission of multimedia information is becoming increasingly important, and streaming technologies, which allow for downloading and playing at the same time, are deeply favored by education, entertainment and other industries. This patent, primarily based on the comment data technology, the streaming media system and major streaming technologies, proposes a method and its apparatus for the transmission of the video stream of the comment data.

RTCWeb (Real-Time Communications Web), a Web application running in a browser, can establish a real-time communications connection between different terminals to transmit media streams (including audio data streams and/or video data streams) by calling an API (Application Programming Interface) provided by the browser.

Compared with conventional VoIP applications, real-time communications are characterized by that: the local control of the media plane and the terminal is realized by the browser running on the terminal, while the signaling plane is realized by the script program (such as a Java script program) embedded in the Web page. More specifically, the media stream transmission channel between different terminals based on a browser and a script program is established in this way: the browser running on the terminal, according to the URL of the real-time communications service website inputted by the user, downloads page data (the page data packet includes a script program) from the corresponding server and presents the corresponding page to the user; then conventional comment data are saved as xml text data in the page script program, read by the script program of each terminal, and presented in the page or video screen on different layers.

More specifically, after each terminal logs on to the server, if the script program captures the information inputted by the user in the input interface (such as the input box of the comment data) presented by the script program, the script program will send the information to the server via the browser; the server, according to the information, will send signaling to the corresponding online terminal, so that the terminals on both ends will establish an end-and-end media stream transmission channel after the online terminal successfully receives the signaling.

In view of the role played by the terminal in the abovementioned process, the system architecture of the terminal that realizes real-time communications can, from the bottom layer to the upper layer, be divided into structures on different layers, including: the bottom layer hardware (including the microphone and other voice input devices), the operating system, the browser, and the script program (or the function unit realized by the script program). The structure on the upper layer can, through an interlayer API, call the structure on the lower layer to realize the service logic function of the structure on the upper layer.

With regard to the abovementioned background of the invention, the conventional way to download a comment data is characterized by that:

(1) The startup delay is rather long. The user needs to wait for all comment data messages to be loaded to the cache before beginning to view the comment data video. Normally, a 45-minute film clip takes several seconds to load its comment data messages. This is acceptable when it comes to conventional text comment data whose data volumes are small. However, it is slow when it comes to new forms of comment data whose data volumes are greater, and one needs to wait when fast forwarding or fast reversing the video.

(2) It requires high system cache capacity. As the Internet is characterized by intermittent asynchronous transmission based on packet transmission, data are transmitted as separated packets, each of which, in a dynamically changing network, may choose different routes, making the delays of the arrival of the packets at the user computers differ. Therefore, the client needs a cache system to offset the impact of delay and dithering and ensure the correct sequence of data packet transmission, so that media data can be outputted continuously; comment data, which are loaded independently, require a reserved cache area for their independent loading, therefore having a high requirement for the cache.

(3) Streaming transmission is realized using specific real-time transmission protocols such as RTSP that better support online streaming real-time transmission of animations, videos and audios. However, comment data need to be broadcasted independently, artificially adding a data stream. Therefore, conventional protocols do not adapt to this type of data transmission.

Our company found in real applications that due to great data volumes, when advanced comment data, such as image comment data, code comment data and other complex, advanced comment data are used, loading a comment data stream independently will make it fail to achieve audio-visual synchronization with the original video, or cause jamming and frame skipping, making the video fail to play smoothly.

### SUMMARY OF THE INVENTION

This invention provides a method and its apparatus for the transmission of the video stream of the comment data, said method comprising: said video stream data including image data, audio data and comment data equally having built-in attribute data; the server receives the comment data having built-in attribute data inputted by the user; the decoder decodes the comment data having attribute data; the player program, according to attribute data, inserts the decoded comment data between the audio data and image data having corresponding attribute data to form said video stream; the player program reads said video stream and plays it; and when said video stream data are played, said image data, audio data and comment data will be synchronically played according to said attribute data.

Said attribute data include timestamp, payload length and synchronization identifier.

Said method for the transmission of the video stream of the comment data includes a decoder, which decodes said video stream data according to said attribute data and play them using a player program; and a player program used to play video streams decoded by said decoder.

Said apparatus includes a terminal that can play said video stream data, said video stream including image data, audio data and comment data equally having built-in attribute data.

Including a server used to store said image data, audio data and comment data equally having built-in attribute data.

Beneficial effects: Compared with the existing technologies, the present invention has the following advantages:
1. The comment data stream is integrated between audio and image data, and the decoder only needs to decode one data stream, thereby saving the bandwidth required by decoding and greatly unleashing the decoding speed of the comment data video;
2. The viewability of the comment data is improved; comment data are directly embedded between audio and image data, the player directly loads current comment data when preloading said video stream, and the comment data is smooth, and fully matches the image and audio stream.
3. The adaptability of advanced comments is enhanced; an advanced comment data, characterized by rather great data volumes, can better match current audio and image data when embedded between video stream data.

### BRIEF DESCRIPTION OF THE DRAWINGS

FIG. 1 is a flow diagram illustrating a method and its apparatus for the transmission of the video stream of the comment data according to the present invention;

FIG. 2 is an effect diagram of the queue data merging of the audio data, video data and the comment data according to the present invention.

The numbering in the diagram:
201—Step 1;
202—Step 2;
203—Step 3;
204—Step 4.

### SPECIFIC EMBODIMENTS

It is worth noting that the following techniques were first recommended to be written using the Node.js program. Preferably, the video file of the present invention is presented in FLU format.

This invention will be described below in a more detailed manner with the aid of appended diagrams. Evidently, the described embodiments are only part of rather than all of the embodiments of the present invention. The following description of at least one exemplary embodiment is only explanatory, and does not limit the present invention and its applications or other uses. All the other embodiments obtained by an ordinary person skilled in the art without creative work will fall within the scope of protection of the present invention.

Unless specified otherwise, the parts, relative arrangements, functions and numerical values mentioned in these embodiments shall not limit the scope of the present invention.

Meanwhile, evidently, to facilitate depiction, the sizes of the parts shown in the appended diagrams are not drawn to scale. Technologies, methods and devices already known to ordinary technicians in relevant arts will not be described in detail. However, when appropriate, said technologies, methods and devices shall be deemed part of the patent grant.

In all the examples shown and discussed herein, any specific value shall be construed as merely illustrative but not limiting. Therefore, other examples of procedural embodiments may have different sequences.

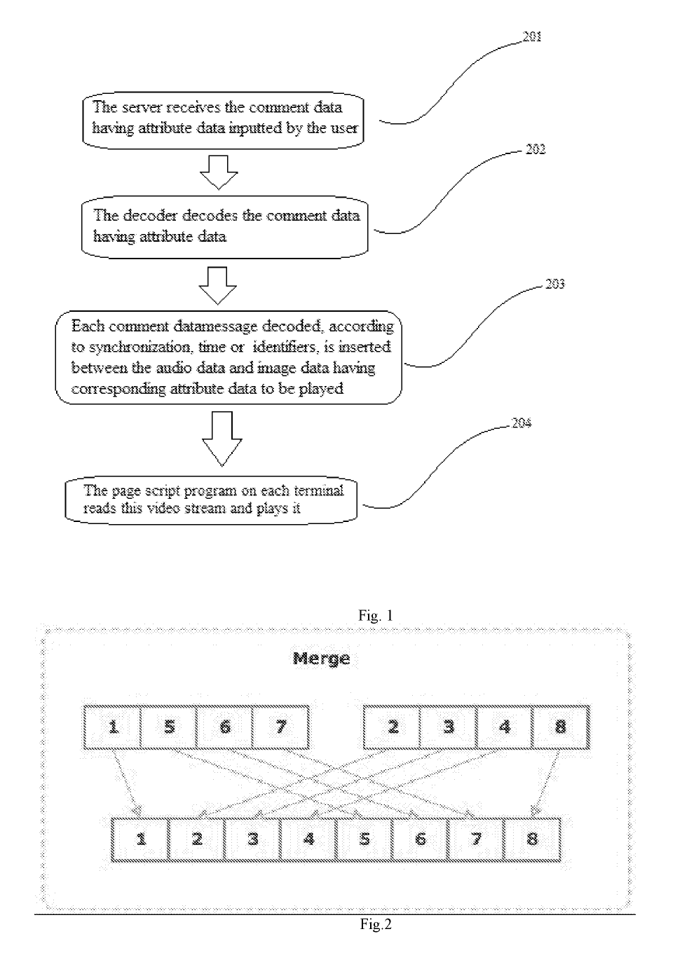

FIG. 1 is a flow diagram illustrating a method and its apparatus for the transmission of the video stream of the comment data according to the present invention.

Wherein, in step 1 (201), the server receives and store the comment data having attribute data inputted by the user; and the user input interface only contains the text data of the comment data, such as xml files.

The comment data in the server is in the FLV format; the attribute data of the comment data includes a timestamp, Payload length, and a synchronization identifier.

In step 2 (202), the decoder decodes the comment data having attribute data; including a timestamp, to determine its position in the video content before and after. The decoding step consists of: The server parses the comment data stored in the radis cache or in the My SQL memory into the script object in flv.tag. The server uses the scriptObjectTag to encapsulate the comment data. Comment data Format:
Type=18

| | |
|---|---|
| Type | Payload length=tag size |
| Time stamp | Timestamp upper |
| Identifier | |

Packet Payload

Payload is for the comment data under current timestamp, use amf 0 format encoding.

In step 3 (203), each comment data message decoded, according to synchronization, timestamp and identifiers, is inserted between the audio data and image data having corresponding attribute data to be played.

In FIG. 2, The server combines the comment data scriptobject.tag and the flv.tag of the audio and video data for queue merging with the timestamp. The values shown in FIG. 2 are equivalent to the beginning and end of the sequence.

The decoder determine the audio and video data fit according to the screen data and audio data comes with the time stamp; The comments video stream of the queue merge is stored in the server in flv format after the completion. When the client sends a video request, the client sends the video cid to the server, the server reads and parses the flv file on the video memory to generate a list of flv.tag containing the audio and video data and comment data and sends a flv sign so that transfer the queue through the merger of the comment data stream into flv format video files and sent to the client. The client in accordance with the timestamp to read the audio and video data tag, comment data tag. And the audio and video data tag and comment data tag respectively to play. The client player program according to the payload length of the comment data so that the player controls the running time of the comment data.

In step 4 (204), the page player program on each terminal reads this video stream and plays it; and the synchronization between audio and image data and comment data is checked to adjust synchronization according to said synchronization identifier. The player program, according to the synchronization identifiers of said comment data message, determines the location of the message in the video;

Conventional video stream transmission involves frame-by-frame image data and bit-by-bit audio data; the decoder determines the integration of audio data and image data according to the time identifiers of screen data and audio data; said decoder, according to the present invention, inserts said comment data between audio and image data according to said time identifiers to form a single comment data video stream data;

Conventional streaming transmission is realized using specific real-time transmission protocols such as RTSP which separated audio and image data earlier, therefore better supporting online streaming real-time transmission of animations, videos and audios, and later integrated audio data and image data to form a single data stream, making dissemination easier; comment data, however, need to be broadcasted independently, artificially adding a data stream, requiring comment data to be preferably integrated.

The multimedia video digital signal codec standards for video data streaming used in the present invention are H.261, H.263, MJPEG, MPEG1, MPEG2 and H.264/MPEG4. Compared with multimedia video digital signal codecs in CD-ROM and TV broadcasting, multimedia digital codecs on the Internet provide videos with higher scalability, lower computational complexity, higher network packet loss compensation and shorter coding/decoding waiting time.

In addition, multimedia digital codecs must be closely linked to network transmission software, so as to maximally improve the frame frequency and image quality.

In a comment data video application, as shown in the diagram, conventional comment data video transmission involves two channels, one of which containing audio and image data; and comment data are independently loaded in the other channel

A method for the transmission of the video stream of the comment data in the present invention includes a decoder, which decodes said video stream data according to said attribute data and plays it using a player.

In existing technologies, decoders can be classified into software decoders, hardware decoders and wireless decoders.

A player includes decoders. As different players include different number and types of decoders, sometimes more decoders need to be added to a player.

In existing technologies, a universal video decoder, integrating popular decoders and splitters, supports normal video formats such as WMV, DVD, MPEG, FLV, AVI, MKV and RM/RMVB and audio formats such as RM, AAC and AC3, and is a universal codec. It consumes few CPU resources and can optimize image quality, and is an indispensable tool for multimedia playback on a Windows platform. After this decoder is installed, any player can be used to play media files in diverse formats, and conversion can be done between such formats as WMV/DVD/FLV/AVI/RMVB using mainstream converters; optimally, the present invention uses the built-in decoder of Flash.

Said apparatus for the transmission of the video stream of the comment data, said apparatus including: a terminal that can play said video stream data, said video stream including image data, audio data and comment data equally having built-in attribute data.

Said method and its apparatus for the transmission of the video stream of the comment data, said apparatus including:
A server used to store said image data, audio data and comment data equally having built-in attribute data.
The server completes the encapsulation of the bar code data.
Said package comprising:
Comment dataFormat:
Type=18

| | |
|---|---|
| Type | Payload length=tag size |
| Time stamp | Timestamp upper |
| Identifier | |

Packet Payload

Payload is for the the comment dataunder current timestam, use amf 0 format encoding.
And said server responds to the client's video play request and sends the stored video data, audio data, and encapsulated comment data.

In existing technologies, a streaming media server is primarily used to transmit video files using a streaming protocol (RTP/RTSP, MMS, RTMP, etc.) to the client to be viewed online by the user; it can also receive real-time video streams from video capture and compression software and then broadcast them directly to said client using a streaming protocol. Typical streaming media servers include Microsoft's Windows Media Service (WMS), which receives and transmits videos using the MMS protocol and uses Windows Media Player (WMP) as the front end player; RealNetworks's Helix Server receives and transmits videos using the RTP/RTSP protocol and uses Real Player as the front end player; and Adobe's Flash Media Server, which receives and transmits videos using the RTMP (RTMPT/RTMPE/RTMPS) protocol and uses Flash Player as the front end player. It's worth noting that Adobe's Flashplayer is becoming an increasingly popular front end player (according to Adobe's official data, Flashplayer's install base exceeded 99%).

The server according to the present invention is a streaming media server using Flashplayer as the front end player and being compatible with Flashplayer; streaming media servers supporting Flashplayer include Adobe Flash Media Server, Sewise's streaming media server software, Ultrant Flash Media Server, and the Java-based, open source software Red5. Software instructions for implementing the detailed functionality can be readily authored by artisans, from the descriptions provided herein, e.g., written in C, C++, Visual Basic, Java, Python, Tcl, Perl, Scheme, Ruby, etc. Mobile devices according to the present technology can include software modules for performing the different functions and acts. Commonly, each device includes operating system soft ware that provides interfaces to hardware resources and general purpose functions, and also includes application software which can be selectively invoked to perform particular tasks desired by a user. Known browser software, communications software, photography apps, and media processing software can be adapted for many of the uses detailed herein. Software and hardware configuration data/instructions are commonly stored as instructions in one or more data structures conveyed by tangible media, such as magnetic or optical discs, memory cards, ROM, etc., which may be accessed across a network. Some embodiments may be implemented as embedded systems—a special purpose computer system in which the operating system software and the application software is indistinguishable to the user (e.g., as is commonly the case in basic cell phones). The functionality detailed in this specification can be implemented in operating system software, application software and/or as embedded system software. In the interest of conciseness, the myriad variations and combinations of the described technology are not cataloged in this document. Applicants recognize and intend that the concepts of this specification can be combined, substituted and interchanged—both among and between themselves, as well as with those known from the cited prior art. Moreover, it will be recognized that the detailed technology can be included with other technologies—current and upcoming—to advantageous effect. To provide a comprehensive disclosure, while complying with the statutory requirement of conciseness, applicants incorporate-by-reference each of the documents referenced herein. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and devices described herein may be embodied in a variety of other forms; furthermore, various omissions, substitutions and changes in the form of the methods and devices described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A method comprising:
receiving content data associated with a presentation of a content item, wherein the content data comprises attribute information corresponding to the content data;
receiving comment data, wherein the comment data comprises a plurality of comment data segments and attribute information corresponding to the plurality of comment data segments;
integrating the plurality of comment data segments into the content data based on their respective attribute information and generating an integrated data stream; and
transmitting, to a client computing device, the integrated data stream.

2. The method of claim 1, wherein attribute information comprises timestamp, payload length, and synchronization identifier.

3. The method of claim 1, wherein the plurality of comment data segments each correspond to a comment on the content item.

4. The method of claim 1, wherein the content data comprise video data and audio data.

5. The method of claim 1, further comprising:
synchronizing presentations of the plurality of comment data segments with the presentation of the content item based on their respective synchronization identifier.

6. A server computing device, comprising instructions that upon execution cause the server computing device at least to:
receive comment data, wherein the comment data comprises a plurality of comment data segments and attribute information corresponding to the plurality of comment data segments;
decode the comment data;
integrate the plurality of comment data segments into stored content data associated with a presentation of a content item based on the attribute information and generate an integrated data stream; and
transmit, to a client computing device, the integrated data stream.

7. The server computing device of claim 6, wherein the attribute information comprises timestamp, payload length, and synchronization identifier.

8. The server computing device of claim 6, wherein the plurality of comment data segments each correspond to a comment on the content item.

9. The server computing device of claim 6, wherein the stored content data comprises video data and audio data.

10. The server computing device of claim 9, wherein the stored content data further comprises attribute information corresponding to the content data.

11. A client computing device, comprising instructions that upon execution cause the client computing device at least to:
receive, from a server computing device, an integrated data stream, wherein the integrated data stream comprises content data associated with a presentation of a content item and comment data associated with a plurality of comments on the content item;
synchronize the comment data with the content data based at least in part on a synchronization identifier; and
display the content item and the plurality of comments.

12. The client computing device of claim 11, wherein the content data comprise video data and audio data.
